(19) United States
(12) Patent Application Publication
(10) Pub. No.: US 2025/0318535 A1
(43) Pub. Date: Oct. 16, 2025

(54) DOUGH MOLD ATTACHMENT ASSEMBLY FOR A STAND MIXER

(71) Applicant: Haier US Appliance Solutions, Inc., Wilmington, DE (US)

(72) Inventors: Danister Abeygunawardana, Jeffersonville, IN (US); Tomas Garces, Louisville, KY (US)

(21) Appl. No.: 18/636,955

(22) Filed: Apr. 16, 2024

(51) Int. Cl. A21C 5/00; A21C 1/02

(52) U.S. Cl. CPC A21C 5/003; A21C 1/02

(57) ABSTRACT

A stand mixer includes a base, a support column coupled to the base and extending upwardly from the base, a head coupled to an upper end of the support column and extending from the support column above the base, and a dough mold attachment assembly. The dough mold attachment assembly includes a dough hopper including an inlet for receiving moldable dough therethrough and an outlet for releasing the moldable dough as a molded dough therefrom, and a dough mold positioned within the dough hopper, the dough mold rotatable relative to the dough hopper and defining a mold cavity for forming the moldable dough into the molded dough as the dough mold is rotated relative to the dough hopper.

### FIELD OF THE INVENTION

The present disclosure relates generally to stand mixers, or more specifically, to the dough mold attachment assembly of a stand mixer.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. Such utensil types connected to the driveshaft(s) often include various auxiliary attachments. While such auxiliary attachment assemblies work well, further improvements are needed.

Accordingly, a stand mixer having a dough mold attachment assembly would be desirable. More specifically, a dough mold attachment assembly that is capable of molding or forming dough into cookie shapes for baking would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a stand mixer including a base, a support column coupled to the base and extending upwardly from the base, a head coupled to an upper end of the support column and extending from the support column above the base, and a dough mold attachment assembly is provided. The dough mold attachment assembly includes a dough hopper including an inlet for receiving moldable dough therethrough and an outlet for releasing the moldable dough as a molded dough therefrom, and a dough mold positioned within the dough hopper and rotatable relative to the dough hopper and defining a mold cavity for forming the moldable dough into the molded dough as the dough mold is rotated relative to the dough hopper.

In another example aspect, a dough mold attachment assembly for a stand mixer including a base, a support column coupled to the base and extending upwardly from the base, and a head coupled to an upper end of the support column and extending from the support column above the base is provided. The dough mold attachment assembly includes a dough hopper including an inlet for receiving moldable dough therethrough and an outlet for releasing the moldable dough as a molded dough therefrom, and a dough mold positioned within the dough hopper and rotatable relative to the dough hopper and defining a mold cavity for forming the moldable dough into the molded dough as the dough mold is rotated relative to the dough hopper.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an example embodiment of a stand mixer of the present disclosure.

FIG. 2 is a perspective view of the example stand mixer of FIG. 1 with an example embodiment of a dough mold attachment assembly coupled to the stand mixer.

FIG. 3 is a perspective view of the example dough mold attachment assembly of FIG. 2.

FIG. 4 is an exploded view of the example dough mold attachment assembly of FIG. 2.

FIG. 5 is a cross-sectional view of the example dough mold attachment assembly of FIG. 2 and a portion of the example stand mixer of FIG. 1 taken generally about Line 5-5 in FIG. 2.

FIG. 6 is a cross-sectional view of the example dough mold attachment assembly of FIG. 2 taken generally about Line 6-6 in FIG. 2.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

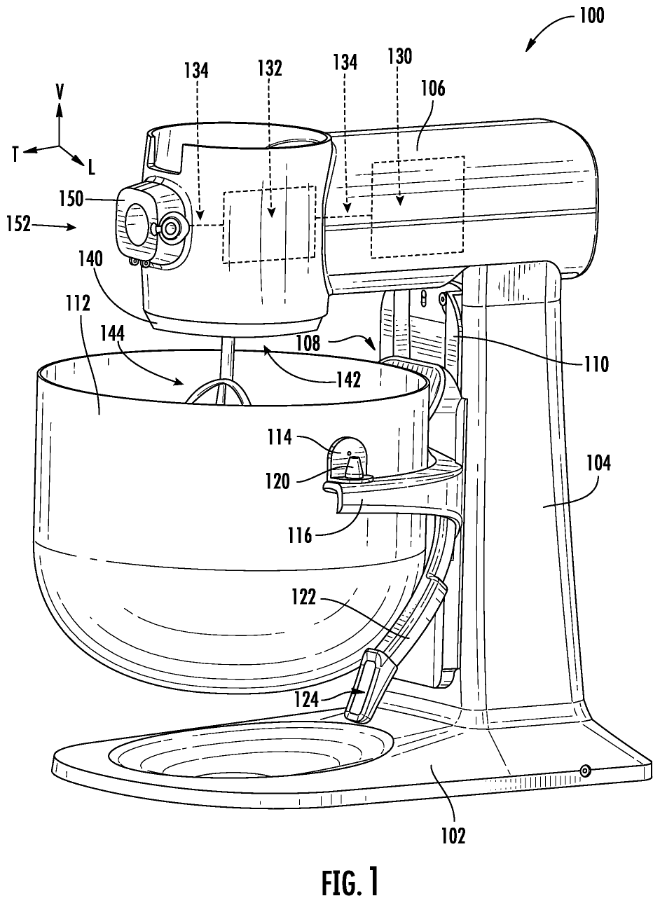

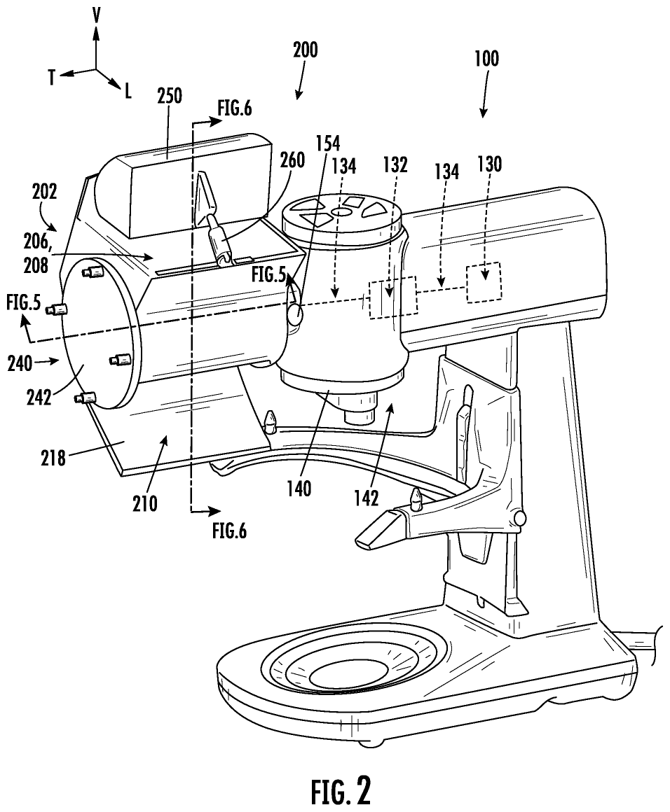

FIGS. 1 and 2 provide perspective views of a stand mixer 100 according to an example embodiment of the present subject matter. It will be understood that stand mixer 100 is provided by way of example only and that the present subject matter may be used in or with any suitable stand mixer in alternative example embodiments. Moreover, with reference to each of FIGS. 1 and 2, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

Stand mixer 100 may include a base 102 and a support post or column 104. Column 104 may include a bowl support 108. Bowl support 108 may slidably mount to a column rail 110, which is mounted to column 104. Additionally, components of bowl support 108 may extend outwardly above the base 102, e.g., in the transverse direction T, and may hold bowl 112 above base 102, e.g., along the vertical direction V. Bowl 112 may be removably mounted on bowl support 108 via flanges 114. Flanges 114 may be on opposite sides of the bowl 112 with respect to the circumference of the bowl.

Additionally, the support column 104 may support a mixer head 106, which is positioned atop column 104. The mixer head 106 may house a motor 130, a gearbox 132, and/or a drivetrain apparatus 134 of stand mixer 100. For example, as shown in FIG. 1, head 106 may be mounted to column 104, which is mounted to base 102. Thus, column 104 may extend between and connect base 102 and head 106, e.g., along the vertical direction V. Head 106 may extend outwardly above the base 102, e.g., in the transverse direction T.

Furthermore, head 106 includes a mixing attachment support 140. Mixing attachment support 140 is located on a lower portion or underside 142 of head 106 and forward of support column 104 along transverse direction T. A rotating mixing attachment 144 is removably coupled to the mixing attachment support 140. The drivetrain apparatus 134 connects the motor 130 with the gearbox 132 and the mixing attachment support 140 such that the motor 130 may drive rotation of the mixing attachment 144 when the mixing attachment 144 is coupled to the mixing attachment support 140. The gearbox 132 may allow user selection of different rotating speeds for the mixing attachment 144. The stand mixer 100 may include one or more controls for operations such as selectively powering the motor 130, choosing the speed of rotation for the mixing attachment 144, and other features. In certain embodiments, the mixing attachment support 140 may accept more than one type of mixing attachment 144. Various types of mixing attachments may be used including e.g., whisks, paddles, dough hooks, beaters, and others for purposes of mixing ingredients within a bowl or other container supported by the base 102. During use, rotation of the mixing attachment 144 may be driven in a circular or planetary manner. Spinning in a planetary manner, as used herein, includes spinning both in a circular manner and rotating about an axis that moves in a circular manner. In some embodiments, the motor 130 may be disposed within base 102, including within the column 104.

Example operation of an exemplary embodiment of the stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on a motor to begin the process of mixing, kneading, beating, etc. The motor rotates an attachment attached to stand mixer 100 to complete each of these processes. The processes may be conducted with a respective attachment such as a mixer blade for mixing, a dough hook for kneading, and a balloon whisk for beating.

As shown in FIG. 1, bowl support 108 may include an arm 116, with a mounting spike 120. Arm 116 may hold bowl 112 via mounting spike 120, which may removably couple to flanges 114. For instance, each mounting spike 120 on arm 116 may be received within a respective flange 114 on bowl 112. Lift lever 122 may rotatably couple to arm 116. There may be at least two lift levers 122. Thus, bowl 112 may be disposed between lift levers 122, e.g., along the lateral direction L. Each lift lever 122 may be positioned on a respective side of bowl 112, such that both a left-handed user and a right-handed user may comfortably operate lift levers 122. Lift lever 122 may have one end 124 cantilevered from support column 104. Such distal end 124 may correspond to a handle for a user to grasp, push, or pull.

Furthermore, as best illustrated in FIGS. 1 and 2, the head 106 includes an auxiliary attachment support 150 located on a forward portion or frontside 152 of head 106 in the transverse direction T and forward of support column 104 in the transverse direction T. An auxiliary attachment assembly, such as dough mold attachment assembly 200 (FIG. 2) for molding or forming cookie dough, is removably coupled to the auxiliary attachment support 150. For example, a removable pin 154 (FIG. 2) may couple the dough mold attachment assembly 200 to the auxiliary attachment support 150. The drivetrain apparatus 134 connects the motor 130 with the gearbox 132 and the auxiliary attachment support 150 such that the motor 130 may drive rotation of various components of the dough mold attachment assembly 200 (FIG. 2) when the dough mold attachment assembly 200 (FIG. 2) is coupled to the auxiliary attachment support 150. In certain embodiments, the auxiliary attachment support 150 may accept more than one type of auxiliary attachment assembly. For example, various types of dough mold attachment assemblies may be used including e.g., pasta extruders, and others for purposes of molding or forming dough into molded shapes.

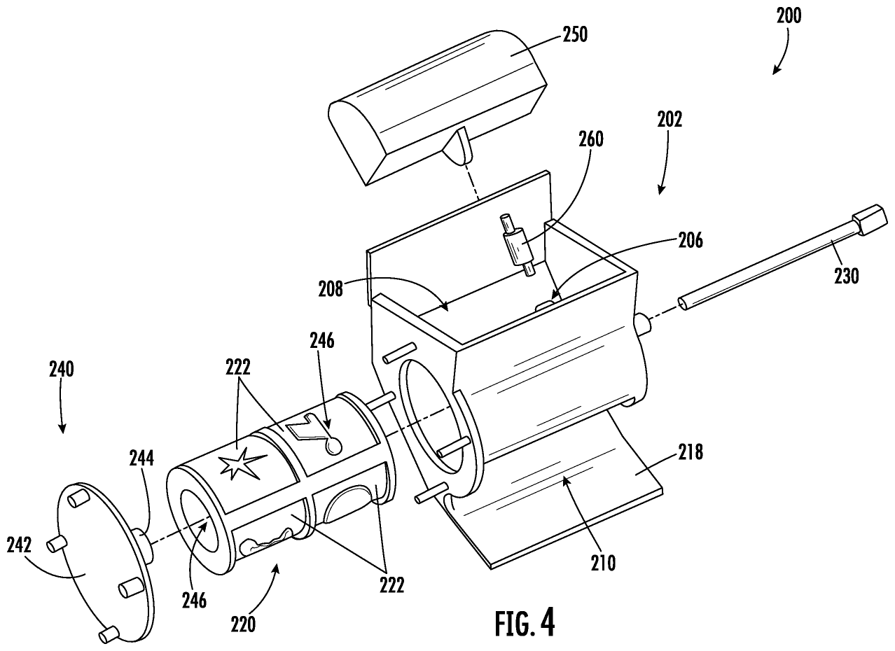

Referring now to FIGS. 2 through 6, the dough mold attachment assembly 200 that may be used with the stand mixer 100 will be described according to example embodiments of the present subject matter.

According to example embodiments, the dough mold attachment assembly 200 may include a dough hopper 202, which, as will be described below, may also house various other components of the dough mold attachment assembly 200 used to form moldable dough, such as cookie dough, into molded dough. Notably, the dough hopper 202 includes an inner wall 204 that defines an interior portion 206 of the dough hopper 202. Additionally, the dough hopper 202 includes an inlet 208 for receiving the moldable dough within the interior portion 206 of the dough hopper 202 through which it will travel and be formed into molded dough. The dough hopper 202 also includes an outlet 210 for releasing the molded dough from the interior portion 206 of the dough hopper 202. The inlet 208 may be an inlet opening defined by the dough hopper 202 for receiving the moldable dough and the outlet 210 may be an outlet opening defined by the dough hopper 202 for releasing the molded dough therefrom. The dough mold attachment assembly 200 may be coupled to the head 106 of the stand mixer 100 such that the inlet 208 is positioned above the interior portion 206 of the dough hopper 202 and the interior portion 206 of the dough hopper 202 is positioned above the outlet 210 in the vertical direction V. In this respect, gravity may act on the moldable dough, thereby pulling the moldable dough through the dough hopper 202.

According to example embodiments, the dough hopper 202 may include a tray 218 protruding therefrom. The tray 218 may extend below and underneath the outlet 210 for receiving or “catching” the molded dough that is released through the outlet 210. Additionally, the dough hopper 202 may include an inlet guard plate 212 protruding therefrom. The inlet guard plate 212 may extend above the inlet 208 to guide the moldable dough into the interior portion 206 of the dough hopper 202 and, thus, reduce or prevent dough from “spilling” or falling out of the dough hopper 202 as it is being received within the inlet 208.

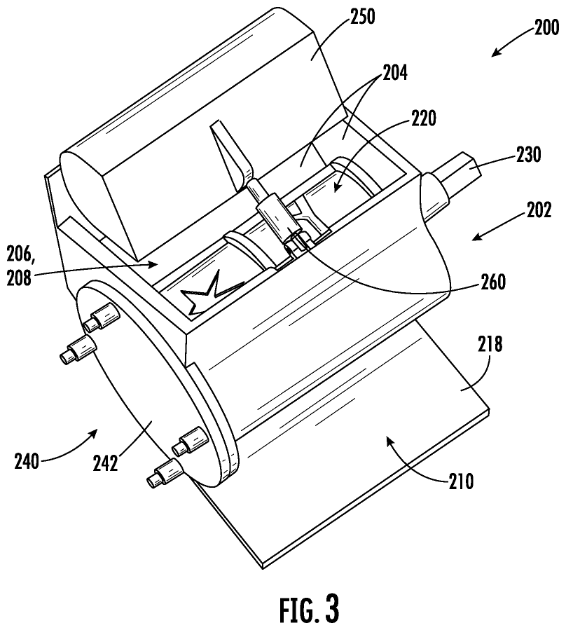

As best illustrated in FIGS. 3 through 6, the dough mold attachment assembly 200 may also include a dough mold 220 for forming the moldable dough into the molded dough. According to example embodiments, the dough mold 220 may be positioned within the interior portion 206 of the dough hopper 202. The dough mold 220 may be rotatable about an axis A relative to the dough hopper 202. Additionally, one or more mold cavities 222 may be defined by an outer surface 224 of the dough mold 220. The mold cavity(ies) 222 may include various patterns (e.g., stars, smiley faces, etc.) for forming the moldable dough into molded dough as the dough mold 220 is rotated relative to the dough hopper 202. Furthermore, each mold cavity 222 may be surrounded by one or more cavity walls 228 for cutting the dough into individual molded dough pieces, such as individual molded cookie dough pieces for baking. In this respect, the cavity wall(s) 228 may be a blade or other cutting mechanism. Each cavity wall 228 may define one of various shapes (e.g., circle, square, etc.) such that the individual molded dough pieces are cut into the corresponding shape.

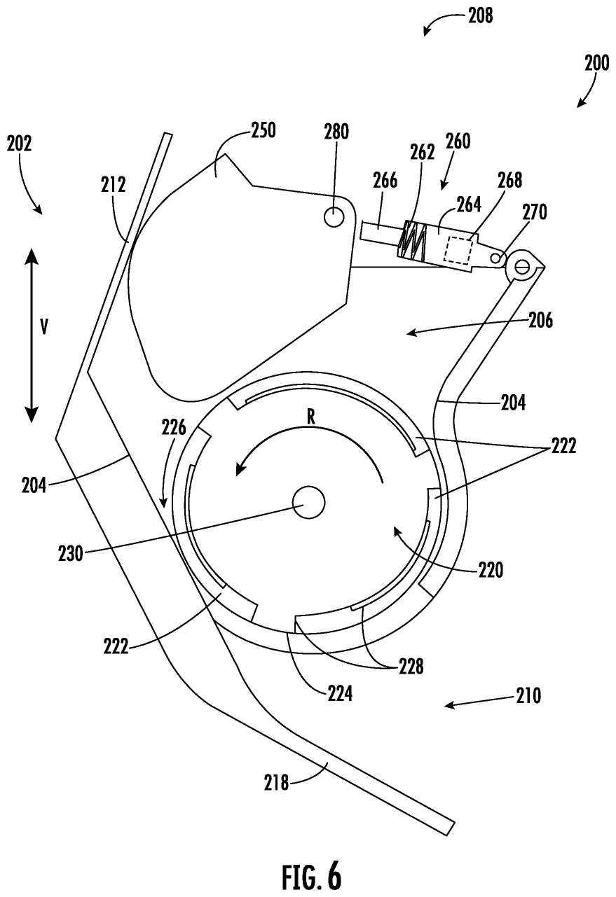

As best illustrated in FIG. 6, a gap 226 is defined between the inner wall 204 of the dough hopper 202 and the dough mold 220. As the dough mold 220 is rotated in the direction R, the moldable dough received within the interior portion 206 of the dough hopper 202 is moved through the gap 226 and within the mold cavity (ies) 222. The moldable dough is thus formed into molded dough by the mold cavity (ies) 222 as it is shaped by the inner wall 204 and the dough mold 220 and cut into shapes by the cavity wall(s) 228 as the moldable dough is moved through the gap 226 by rotation of the dough mold 220. Additionally, the outlet 210 of the dough hopper 220 may be positioned below the dough mold 220 such that, after the moldable dough is formed into the molded dough, the molded dough “drops” or is otherwise released from the mold cavity (ies) 222 and through the outlet 210 when the dough mold 220 has been rotated to a position in which the mold cavity (ies) 222 face the outlet 210.

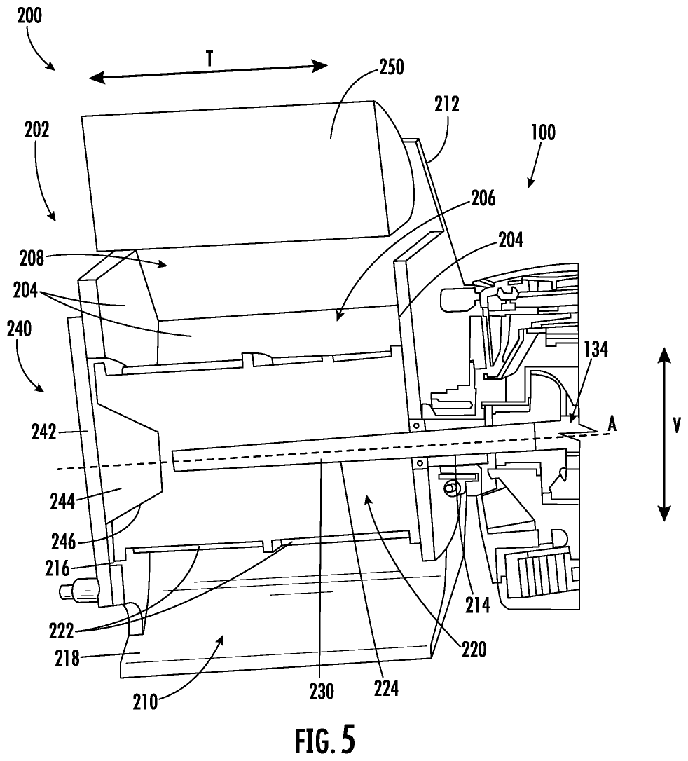

According to example embodiments, the dough mold attachment assembly 200 may also include a drive shaft 230 rotatable about the axis A and coupled to the dough mold 220 such that rotation of the drive shaft 230 results in rotation of the dough mold 220 with the drive shaft 230. As best illustrated in FIG. 5, the dough hopper 202 may define a drive shaft opening 214 for receiving the drive shaft 230 therethrough. Additionally, a drive shaft chamber 224 may be defined within the dough mold 220 and aligned with the drive shaft opening 214 for receiving a portion of the drive shaft 230 therein. The drive shaft chamber 224 and the drive shaft 230 may have complementary cross-sectional shapes, such as “D” shapes best illustrated in FIG. 6 or rectangular shapes, that allow the drive shaft 230 to pull or rotate the dough mold 220 simultaneously with the drive shaft 230. Additionally, the complementary cross-sectional shapes of the drive shaft chamber 224 and the drive shaft 230 may limit or prevent the dough mold 220 and the drive shaft 230 from rotating relative to each other during simultaneous rotation. Furthermore, as best illustrated in FIG. 5, the drive shaft 230 may be coupled to the drivetrain apparatus 134 of the stand mixer 100 such that the motor 130 of the stand mixer 100 drives rotation of the drive shaft 230 and, thus, the dough mold 220.

According to example embodiments, the dough mold attachment assembly 200 may also include an end cap assembly 240 removably coupled to the dough hopper 202. As best illustrated in FIG. 5, the end cap assembly 240 includes a cover portion 242 and a rotatable bearing portion 244 protruding from the cover portion 242 for facilitating rotation of the dough mold 220 about the axis A within the dough hopper 202. As such, the rotatable bearing portion 244 of the end cap assembly 240 extends through a bearing opening 216 defined by the dough hopper 202 for receiving the rotatable bearing portion 244 within the interior portion 206 of the dough hopper 202. Additionally, the dough mold 220 defines a bearing chamber 246 which may be aligned with the bearing opening 216 of the dough hopper 202 for receiving the bearing portion 244 therein. Moreover, the cover portion 242 of the end cap assembly 240 may be fixedly coupled to the dough hopper 202 such that the cover portion 242 covers the bearing opening 216 of the dough hopper 202.

According to example embodiments, the dough mold attachment assembly 200 may also include a dough feeder block 250 for moving the moldable dough toward the dough mold 220. As best illustrated in FIGS. 3, 5, and 6, the dough feeder block 250 may be a weighted block positioned above the dough mold 220 in the vertical direction V. The moldable dough may be positioned between the dough feeder block 250 and the dough mold 220. In this respect, the weight of the dough feeder block 250 may move the moldable dough toward the dough mold 220. Additionally, the dough feeder block 220 may be pivotably coupled to the dough hopper 202 by, for example, one or more linear actuators 260 that will be described below.

According to example embodiments, the dough mold attachment assembly 200 may also include the linear actuator(s) 260. As best illustrated in FIGS. 3 and 6, the linear actuator(s) 260 may be pivotably coupled to the dough hopper 202 and the dough feeder block 250 for facilitating pivoting of the dough feeder block 250. Notably, the linear actuator(s) 260 may be pivotably coupled to the dough hopper 202 at a first pivot joint 270 for facilitating pivoting of the dough feeder block 250 relative to the dough hopper 202. As such, the linear actuator(s) 260 and, thus, the dough feeder block 250, may pivot about the first pivot joint 270 as the weight of the dough feeder block 250 moves the moldable dough toward the dough mold 220.

Furthermore, the linear actuator(s) 260 may be pivotably coupled to the dough feeder block 250 at a second pivot joint 280 for facilitating pivoting of the dough feeder block 250 relative to the linear actuator(s) 260. The linear actuator(s) 260 may be linearly moveable between an extended position (FIG. 6) in which the linear actuator(s) 260 pivots the dough feeder block 250 downward in the vertical direction V about the second pivot joint 280, and a retracted position (not shown) in which the linear actuator(s) 260 pivots the dough feeder block 250 upward in the vertical direction V about the second pivot joint 280. As such, the dough feeder block 250 moves the moldable dough toward the dough mold 220 as the linear actuator(s) 260 is moved from the retracted position toward the extended position.

According to example embodiments, the linear actuator(s) 260 may include a biasing element 262 for moving the linear actuator(s) 260 between the retracted position and the extended position. For example, the linear actuator(s) 260 may include a base 264 and a rod 266 moveable relative to the base 264 between the retracted position and the extended position. The biasing element 262 may be housed within the base 264 and press against or push the rod 266 to move the rod 266 toward the extended position.

Additionally, or alternatively, the linear actuator(s) 260 may include an actuator motor 268 for moving the linear actuator(s) 260 between the retracted position and the extended position. In the example described above, the actuator motor 268 may drive movement of the rod 266 between the retracted position and the extended position.

As explained herein, aspects of the present subject matter are generally directed to a dough mold attachment assembly of a stand mixer that includes a dough hopper for receiving moldable dough, such as moldable cookie dough, and a rotatable dough mold driven by the motor of the stand mixer and defining one or more mold cavities for forming and cutting the moldable dough into molded dough. In addition to rotation of the dough mold, a dough feeder block and a linear actuator may assist with moving the moldable dough toward the rotatable dough mold. Thereafter, the moldable dough is moved through a gap between the inner wall of the dough hopper and the dough mold and shaped and cut as the mold cavity (ies) form the moldable dough into molded dough, such as individual molded cookie dough pieces for baking. This dough mold attachment assembly that is usable with a stand mixer may advantageously provide molding or forming cookie dough into cookie shapes for baking so that separate tools/machinery are not necessary. A user may thus use the machinery they already own or have access to (i.e., stand mixer) to mold cookie dough.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer, comprising:
a base;
a support column coupled to the base and extending upwardly from the base;
a head coupled to an upper end of the support column and extending from the support column above the base; and
a dough mold attachment assembly, the dough mold attachment assembly comprising:
a dough hopper including an inlet for receiving moldable dough therethrough and an outlet for releasing the moldable dough as a molded dough therefrom; and
a dough mold positioned within the dough hopper, the dough mold rotatable relative to the dough hopper and defining a mold cavity for forming the moldable dough into the molded dough as the dough mold is rotated relative to the dough hopper.

2. The stand mixer of claim 1, the dough mold attachment assembly further comprising:
a dough feeder block for moving the moldable dough toward the dough mold.

3. The stand mixer of claim 2, wherein:
the dough feeder block is pivotably coupled to the dough hopper; and
the dough feeder block moves the moldable dough toward the dough mold when the dough feeder block is pivoted.

4. The stand mixer of claim 3, the dough mold attachment assembly further comprising:
a linear actuator pivotably coupled to the dough hopper or the dough feeder block for facilitating pivoting of the dough feeder block.

5. The stand mixer of claim 4, wherein:
the linear actuator is pivotably coupled to the dough hopper at a first pivot joint for facilitating pivoting of the dough feeder block relative to the dough hopper.

6. The stand mixer of claim 4, wherein:
the linear actuator is coupled to the dough feeder block at a second pivot joint for facilitating pivoting of the dough feeder block relative to the linear actuator;
the linear actuator is moveable between a retracted position and an extended position; and
movement of the linear actuator between the retracted position and the extended position results in pivoting of the dough feeder block relative to the linear actuator.

7. The stand mixer of claim 6, the linear actuator of the dough mold attachment assembly comprising a biasing element for moving the linear actuator between the retracted position and the extended position.

8. The stand mixer of claim 6, the linear actuator of the dough mold attachment assembly comprising a motor for moving the linear actuator between the retracted position and the extended position.

9. The stand mixer of claim 1, the dough mold attachment assembly further comprising:
a rotatable drive shaft coupled to a motor of the stand mixer for driving rotation of the rotatable drive shaft, the rotatable drive shaft further coupled to the dough mold such that rotation of the drive shaft results in rotation of the dough mold with the drive shaft.

10. The stand mixer of claim 1, wherein:
the dough mold defines a bearing chamber for receiving a bearing therein;
the dough hopper defines a bearing opening for receiving the bearing therein, the bearing opening aligned with the bearing chamber;
the dough mold attachment assembly further comprises:
an end cap assembly removably coupled to the dough hopper such that the end cap assembly covers the bearing opening, the end cap including a rotatable bearing portion extending within the dough hopper through the bearing opening and within the bearing chamber of the dough mold; and
the rotatable bearing portion of the end cap facilitates rotation of the dough mold within the dough hopper.

11. The stand mixer of claim 1, the dough hopper of the dough mold assembly further comprising:
an inner wall; and
wherein:
a gap is defined between the dough mold and the inner wall of the dough hopper; and
rotation of the dough mold moves the moldable dough through the gap and within the mold cavity of the dough mold to form molded dough.

12. The stand mixer of claim 1, wherein:
the outlet of the dough hopper is positioned below the dough mold; and
the molded dough is released from the mold cavity of the dough mold through the outlet when the mold cavity faces the outlet.

13. The stand mixer of claim 12, the dough hopper of the dough mold attachment assembly further comprising:
a tray extending below the outlet for receiving the molded dough released through the outlet.

14. The stand mixer of claim 1, wherein the dough mold attachment assembly is removably coupled to the head.

15. A dough mold attachment assembly for a stand mixer, the stand mixer including a base, a support column coupled to the base and extending upwardly from the base, and a head coupled to an upper end of the support column and extending from the support column above the base, the dough mold attachment assembly comprising:
a dough hopper including an inlet for receiving moldable dough therethrough and an outlet for releasing the moldable dough as a molded dough therefrom; and
a dough mold positioned within the dough hopper, the dough mold rotatable relative to the dough hopper and defining a mold cavity for forming the moldable dough into the molded dough as the dough mold is rotated relative to the dough hopper.

16. The dough mold attachment assembly of claim 15, further comprising:
a dough feeder block for moving the moldable dough toward the dough mold.

17. The dough mold attachment assembly of claim 16, wherein:
the dough feeder block is pivotably coupled to the dough hopper; and
the dough feeder block moves the moldable dough toward the dough mold when the dough feeder block is pivoted.

18. The dough mold attachment assembly of claim 17, further comprising:
a linear actuator pivotably coupled to the dough hopper or the dough feeder block for facilitating pivoting of the dough feeder block.

19. The dough mold attachment assembly of claim 18, wherein:
the linear actuator is pivotably coupled to the dough hopper at a first pivot joint for facilitating pivoting of the dough feeder block relative to the dough hopper;
the linear actuator is coupled to the dough feeder block at a second pivot joint for facilitating pivoting of the dough feeder block relative to the linear actuator;
the linear actuator is moveable between a retracted position and an extended position; and
movement of the linear actuator between the retracted position and the extended position results in pivoting of the dough feeder block relative to the linear actuator.

20. The dough mold attachment assembly of claim 15, further comprising:
a rotatable drive shaft coupled to a motor of the stand mixer for driving rotation of the rotatable drive shaft, the rotatable drive shaft further coupled to the dough mold such that rotation of the drive shaft results in rotation of the dough mold with the drive shaft.
